(19) United States
(12) Patent Application Publication
(10) Pub. No.: US 2002/0107620 A1
(43) Pub. Date: Aug. 8, 2002

(54) Adaptive electronic control suspension system and a control method of the system

(76) Inventor: Nak-Hwan Kim, Kyonggi-do (KR)

Correspondence Address: LACKENBACH SIEGEL, ONE CHASE ROAD, SCARSDALE, NY, 10583, US

(21) Appl. No.: 10/107,126

(22) Filed: Mar. 28, 2002

Related U.S. Application Data
(62) Division of application No. 09/222,502, filed on Dec. 29, 1998.

(30) Foreign Application Priority Data
Dec. 30, 1997 (KR) 97-77574

(51) Int. Cl. B60G 17/02

(52) U.S. Cl. 701/37; 280/5.515

(57) ABSTRACT

According to the controller for an adaptive electronic suspension system and the control method of the system, it becomes possible to improve the driving performance and steering stability by controlling the damping force of the variable damper considering vehicle speed, steering angle, opening amount of throttle valve, up/down acceleration, brake operation, axle acceleration etc., wherein the controller for an adaptive electronic suspension system includes a vehicle speed sensor, a steering angle sensor, a throttle position sensor, an up/down acceleration sensor, a brake switch, an axle acceleration sensor and an electronic controller for controlling to convert damping force of dampers of four wheels into “hard mode”, “medium mode” and “soft mode” by checking up driving state of the vehicle according to detecting signals output from the sensors and driving front and rear actuators to change passages by rotation of control rods.

### BACKGROUND OF THE INVENTION

1. Field of the Invention

The present invention relates to an adaptive electronic control suspension system and a control method of the system, and more particularly to, an adaptive electronic control suspension system and a control method of the system in which a damping force of a variable damper is controlled according to a vehicle speed, a steering angle, an opening amount of a throttle valve, an up/down acceleration, a brake operation state, and an axle acceleration to improve driving performance and steering stability.

2. Description of the Conventional Art

In general, a vehicle includes a suspension system connecting an axle and a vehicle body to prevent vibration or impact of the axle from road surfaces from being directly transmitted to the body, thereby improving driving performance and stability.

The suspension system is to transmit driving force and damping force, which are generated from respective driving wheels, to bear centrifugal force in case of turning and to maintain the driving wheels at proper positions with relation to the vehicle body. Therefore, the suspension system requires flexible coupling in the up and down directions to observe the impact from the road surface as well as strong coupling in the horizontal direction to bear the driving and the damping force from the driving wheels and the centrifugal force in case of turning.

The suspension system controls the damping force of a variable damper according to a driving speed, braking operation and acceleration operation of a vehicle, wherein the damping force of the variable damper is controlled by driving a stepping motor, that is, an actuator.

In other words, the variable damper includes a control rod and changes the damping force by changing a passage through rotation of the control rod under the driving of the actuator.

FIG. 1 shows a block diagram of a conventional electronic suspension system for vehicles. In FIG. 1, a conventional electronic suspension system of a vehicle includes a steering angle sensor 101 for detecting a steering angle, a TPS Throttle Position Sensor 102 for detecting an opening amount of a throttle valve which is mounted on an intake manifold, a vehicle speed sensor 103 for detecting a vehicle speed, a brake switch 104 for detecting a brake state, an longitudinal acceleration sensor 105 for detecting an acceleration in the up and down directions of the vehicle, and an electronic controller 106 for controlling damping forces of dampers of four wheels into “hard mode”, “medium mode” and “soft mode” in such a manner that a driving state of the vehicle is determined according to output detecting signals from the vehicle sensors 101, 102, 103, 105 and the brake switch 104, and front actuators 107 and rear actuators 108 which are mounted on upper parts of the wheel dampers for changing passages by rotation of control rods.

In the conventional electronic suspension system as above, the electronic controller 106 converts the front and rear actuators 107 and 108 into “hard mode” when the steering angular speed which is detected by the steering angular sensor 101 is a predetermined angular speed 80 deg/sec or higher in case of a sudden steering. On the other hand, the electronic controller 106 converts the front and rear actuators 107 and 108 into “medium mode” when the vehicle speed which is detected by the vehicle speed sensor 103 is a predetermined speed 30 km/h or higher and the opening amount of the throttle valve is detected by the TPS 102 60% or more in case of a sudden accelerating. Further the electronic controller 10 converts the front and rear actuators 107 and 108 into “medium mode” when a longitudinal acceleration which is detected by the longitudinal acceleration sensor 105 is a predetermined angle 0.32 g or more.

If the vehicle speed is a predetermined speed 40 km/h or higher and the brake is in operation so that the brake switch 104 is turned “on”, then the electronic controller 106 converts the front and rear actuators 107 and 108 into “hard mode” to maintain driving stability of the vehicle in case of respective high speed and low speed cases according to vehicle speed signals.

That is, the electronic controller 106 converts the front and rear actuators 107 and 108 into “hard mode” in case where the vehicle speed is a predetermined low vehicle speed 10 km/h or smaller, and into “medium mode” in case where the vehicle speed is higher than the predetermined vehicle speed 10 km/h but lower than a predetermined high speed 120 km/h.

Further, the electronic controller 106 includes a checkup function to checking up as to whether operations of the front and rear actuators 107 and 108 are in normal and a diagnosis function for trouble shooting by monitoring.

However, the conventional electronic suspension system has a disadvantage that it is impossible to assure of vehicle stability in case of a sudden steering, since the suspension system is controlled with a same value without considering vehicle speeds.

The conventional electronic suspension system has a further disadvantage that it is impossible to assure of comfortable driving in case of a sudden accelerating, since the suspension system is controlled with only a change in the opening amount of the throttle valve without considering the vehicle speeds.

The conventional electronic suspension system has further problems that the stability is not achieved in the longitudinal acceleration sensor due to the omission of the vehicle speed consideration.

Further, the checkup function for checking whether the actuators are in normal operations is carried out simultaneously for both front and rear wheels, so that it is impossible to find out troubles accurately.

### SUMMARY OF THE INVENTION

The present invention is derived to resolve the disadvantages of the conventional techniques and it is an object of the present invention to provide an adaptive electronic control suspension system and a control method of the system, in which a damping force of a variable damper is controlled according to vehicle speed, steering angle, opening amount of a throttle valve, up/down acceleration, brake operation state, and axle acceleration, so as to improve driving performance and steering stability.

In order to achieve the above objects of the present invention, according one aspect of the present invention, a control method for an adaptive electronic suspension system includes the steps of sensing a vehicle speed by a detecting signal which is output from a vehicle speed sensor, sensing a steering angle by a detecting signal which is output from a steering angle sensor, computing an odd number variable S from the vehicle speed and the steering angle, determining whether the odd number variable S is smaller than a predetermined value Crl or not, and converting a damping force of a wheel damper into “hard mode” when the odd number variable S is larger, and converting the damping force of the wheel damper into “soft mode” after a time delay when the odd number variable S is smaller and a damping force of a wheel damper is in “hard mode”.

According another aspect of the present invention, a control method for an adaptive electronic suspension system includes the steps of sensing a vehicle speed by a detecting signal which is output from a vehicle speed sensor, sensing an opening amount of a throttle valve mounted on an intake manifold by a detecting signal which is output from a TPS Throttle Position Sensor, differentiating the opening amount of the throttle valve from the throttle position sensor, computing a squirt variable Q from the opening amount of the throttle valve from the throttle position sensor, determining as to whether the squirt variable Q is smaller than a predetermined value Crl, and converting a damping force of a wheel damper into “medium mode” when the squirt variable Q is larger than the predetermined value Crl, while converting the damping force of the wheel damper into “soft mode” when the squirt variable Q is smaller than the predetermined value and the damping mode of the wheel damper is in “medium mode”.

According another aspect of the present invention, a control method for an adaptive electronic suspension system includes the steps of sensing a vehicle speed by a detecting signal which is output from a vehicle speed sensor, sensing an up/down acceleration value G according to an output detecting signal from an up/down acceleration sensor, reading a value of control map, determining as to whether a vehicle speed of a vehicle speed sensor is smaller than or equal to a reference vehicle speed, determining as to whether an absolute value of the up/down acceleration value G is larger than or equal to a predetermined value g1 when the vehicle speed is smaller than or equal to the reference value V1, converting a damping force of a wheel damper into “hard model” when the absolute value of the up/down acceleration value G is larger than or equal to the predetermined value g1, converting a damping force of a wheel damper from “hard mode” into “soft mode” in sequence, when the absolute value of the up/down acceleration value G is smaller than the predetermined value g1, or when the vehicle speed is smaller than the absolute value of the up/down acceleration value G and predetermined values g, g2 in comparison of the vehicle speed with the reference vehicle speed value V3, and comparing the absolute value of the up/down acceleration speed value G with the predetermined values g, g2 according to sizes of the vehicle speed and the reference vehicle speed value V3 if the vehicle speed is smaller than the reference vehicle speed V1, so as to convert the damping force of the wheel damper into “hard mode” when the absolute value of the up/down acceleration speed value is larger than or equal to the predetermined values g, g2.

According another aspect of the present invention, a control method for an adaptive electronic suspension system includes the steps of determining operation state of a brake switch, computing a damping force dV by reading vehicle speed, comparing a random damping speed dV1 with the damping speed dV, converting a damping force of a wheel damper into “soft mode” after a predetermined time lapse, when the damping speed dV is smaller than the predetermined damping speed dV1 or it is in “hard mode” and the brake is not in operation, and converting the damping force of the wheel damper into “hard mode” when the damping speed dV is larger than the predetermined damping speed dV1 but smaller than the predetermined damping speed dV2, while converting a damping force of the wheel damper into “hard mode” during blinking an emergency warning light when the damping speed dV is larger than the random damping speed dV2.

According another aspect of the present invention, a control method for an adaptive electronic suspension system includes the steps of sensing a vehicle speed by a detecting signal which is output from a vehicle speed sensor, determining as to whether the vehicle speed is smaller than 5 km/h to convert a damping force of a wheel damper into “hard mode” if smaller and determining as to whether the vehicle speed is larger than a predetermined vehicle speed V3 if not smaller, converting the damping force of the wheel damper according to change of vehicle speed if the vehicle speed is not larger than the predetermined vehicle speed V3, and comparing the vehicle speed with a predetermined vehicle speed V4 to convert the damping force of the wheel damper if the vehicle speed is larger than the predetermined vehicle speed V3.

According another aspect of the present invention, a control method for an adaptive electronic suspension system includes the steps of obtaining a frequency ratio W, a surface roughness R and a surface height H by processing an up/down acceleration value and an axle acceleration value, obtaining a variable Wc in relation to the frequency ratio W and the surface roughness R, comparing the variable Wc with “0” so as to convert a damping force of a wheel damper into “hard mode” when the variable Wc is larger than “0” and to convert the damping force of the wheel damper according to the surface roughness R, and checking the damping force of the wheel damper when the variable Wc is not larger than “0” so as to convert the damping force of the wheel damper into “soft mode” in case of “hard mode”, and to convert the damping force of the wheel damper into “medium mode” or “soft mode” according to the surface roughness R in case of any other mode than “hard mode”.

### BRIEF DESCRIPTION OF THE DRAWINGS

The present invention will become more fully understood from the detailed description given hereinbelow with reference to the accompanying drawings which are given by way of illustration only, and thus are not limitative of the present invention, and wherein:

FIG. 1 is a schematic block diagram showing a conventional method for controlling an electronic suspension system;

FIG. 2 is a system for controlling an adaptive electronic suspension system according to a preferred embodiment of the present invention; and

FIGS. 3 to 8 are flowcharts for explaining operations of the adaptive electronic suspension system according to the present invention.

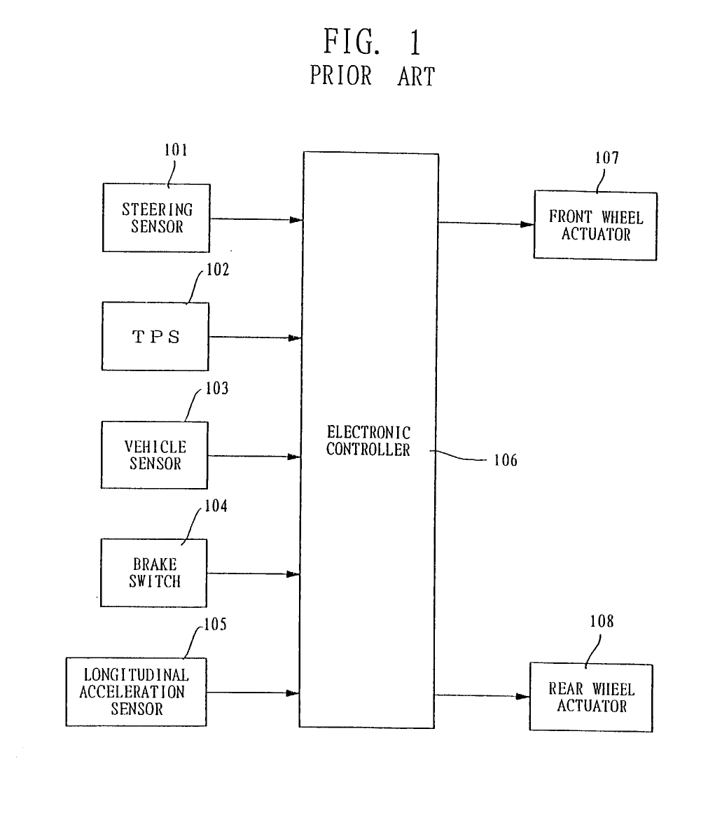

### DETAILED DESCRIPTION OF THE INVENTION

An adaptive electronic control suspension system and a control method of the system according to a preferred embodiment of the present invention will be explained in detail with reference to the hereinbelow accompanying drawings.

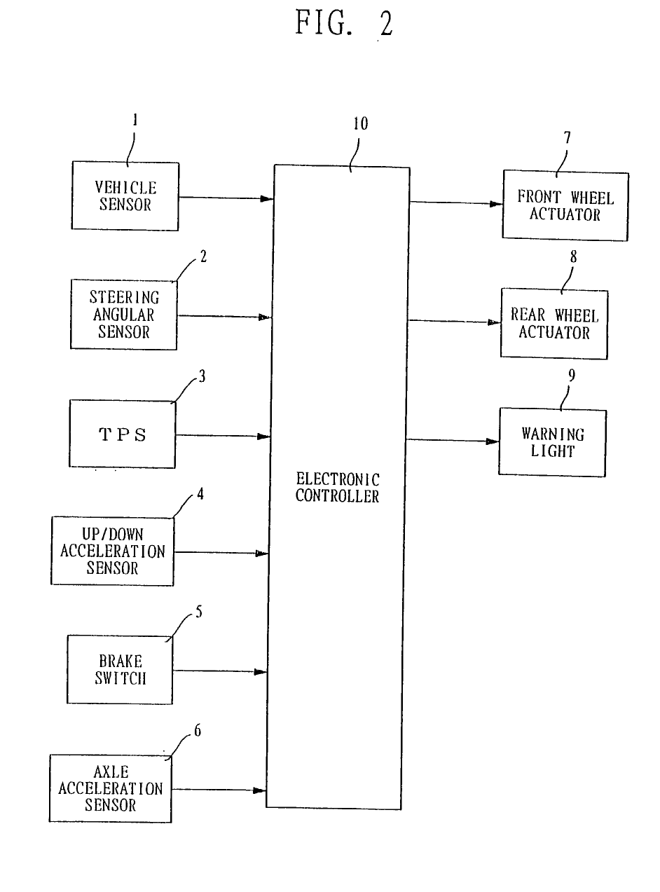

FIG. 2 illustrates a block diagram for explaining the construction of the adaptive electronic suspension system according to a preferred embodiment of the present invention. In FIG. 2, the adaptive electronic suspension system includes a vehicle speed sensor 1 for detecting a vehicle speed, a steering angle sensor 2 for detecting a steering angle, a TPS Throttle Position Sensor 3 for detecting an opening amount of a throttle valve which is mounted on an intake manifold, an up/down acceleration sensor 4 for detecting an acceleration in the up and down directions of a vehicle, a brake switch 5 for detecting whether a brake in operation or not, an axle acceleration sensor 6 for detecting an acceleration in the direction of axle of the vehicle, and an electronic controller 10 for controlling damping forces of dampers of four wheels into “hard mode”, “medium mode” and “soft mode” in such a manner that a driving state of the vehicle is determined according to detecting signals output from the vehicle sensor 1, the steering angle sensor 2, the TPS 3, the up/down acceleration sensor 4, the axle acceleration sensor 6 and the brake switch 5, and front and rear actuators 7 and 8 which are mounted on upper parts of the wheel dampers are driven to change passages by rotation of control rods.

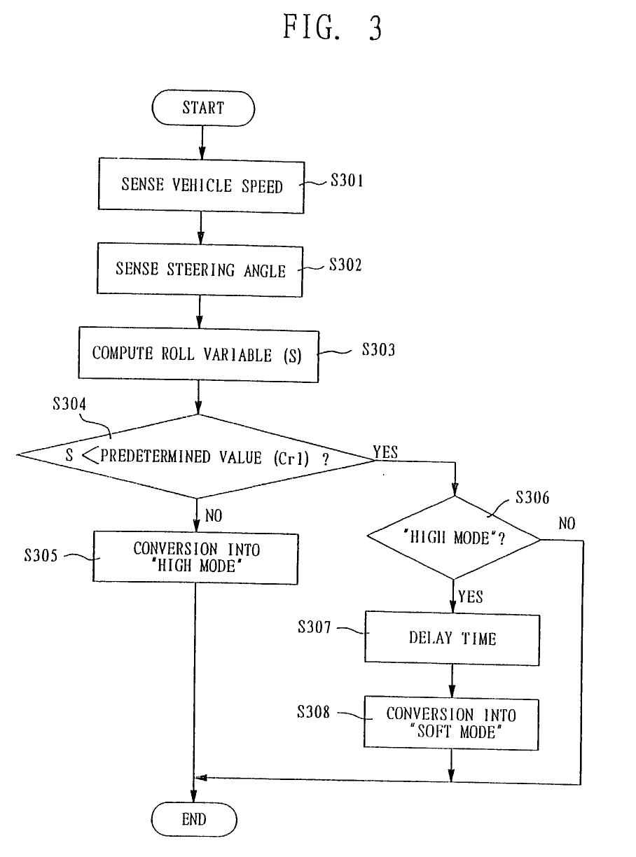

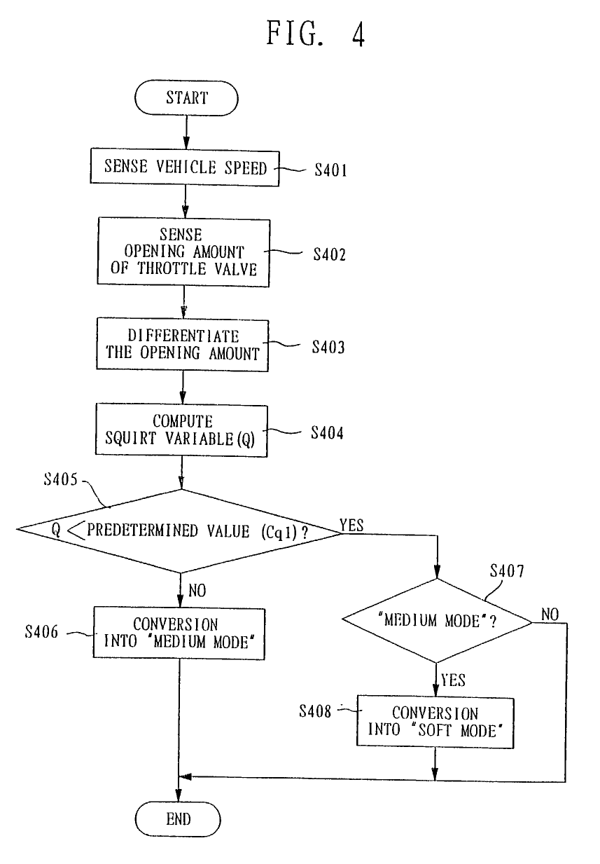

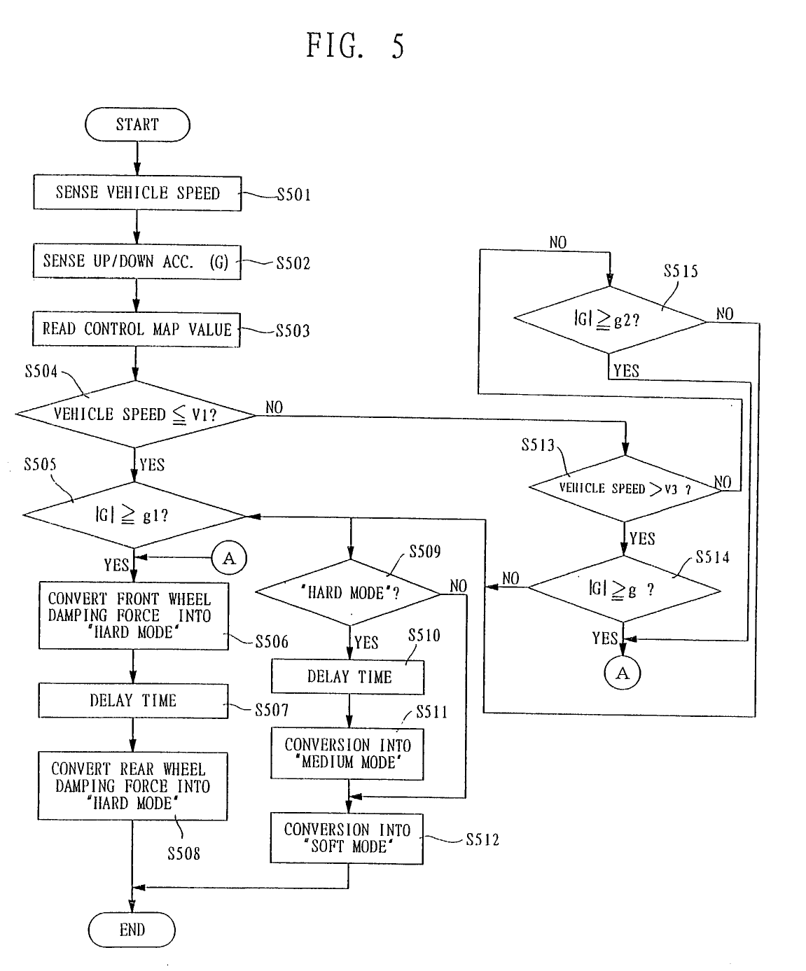

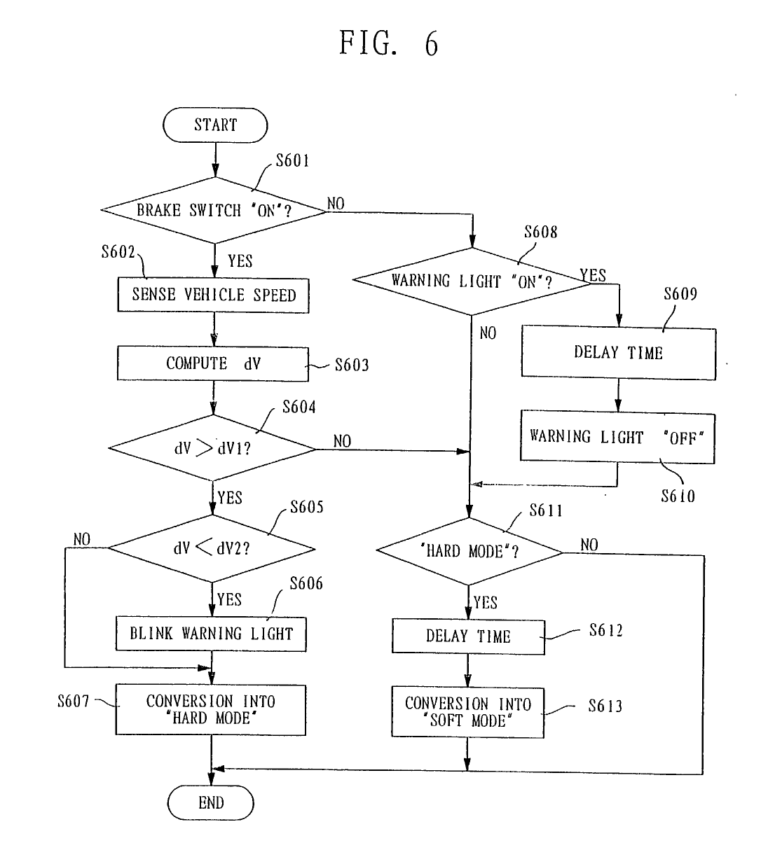

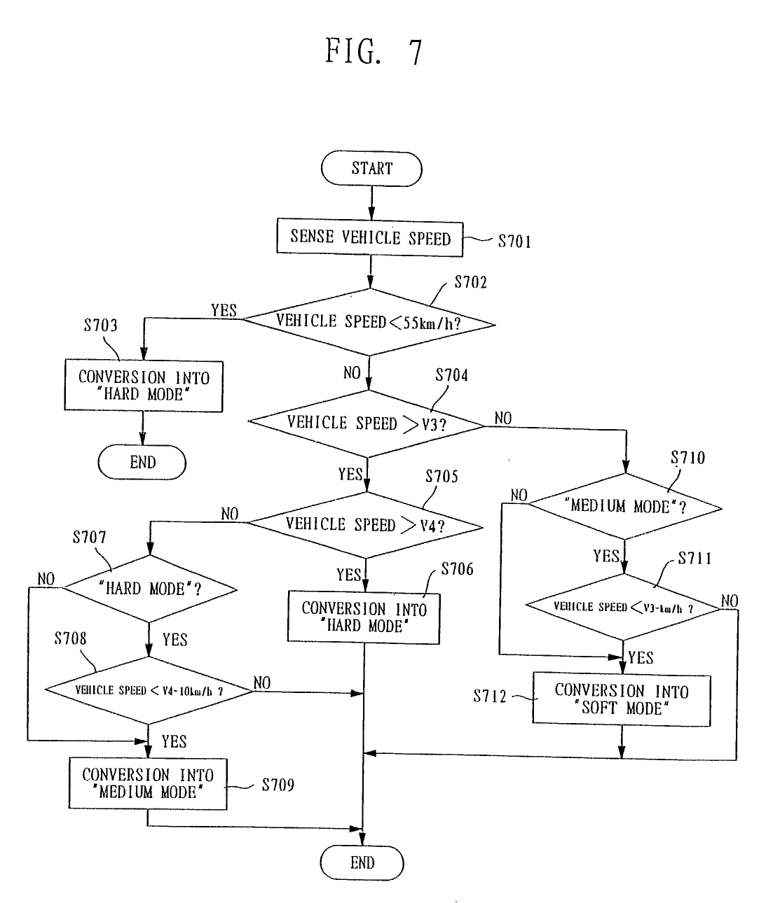

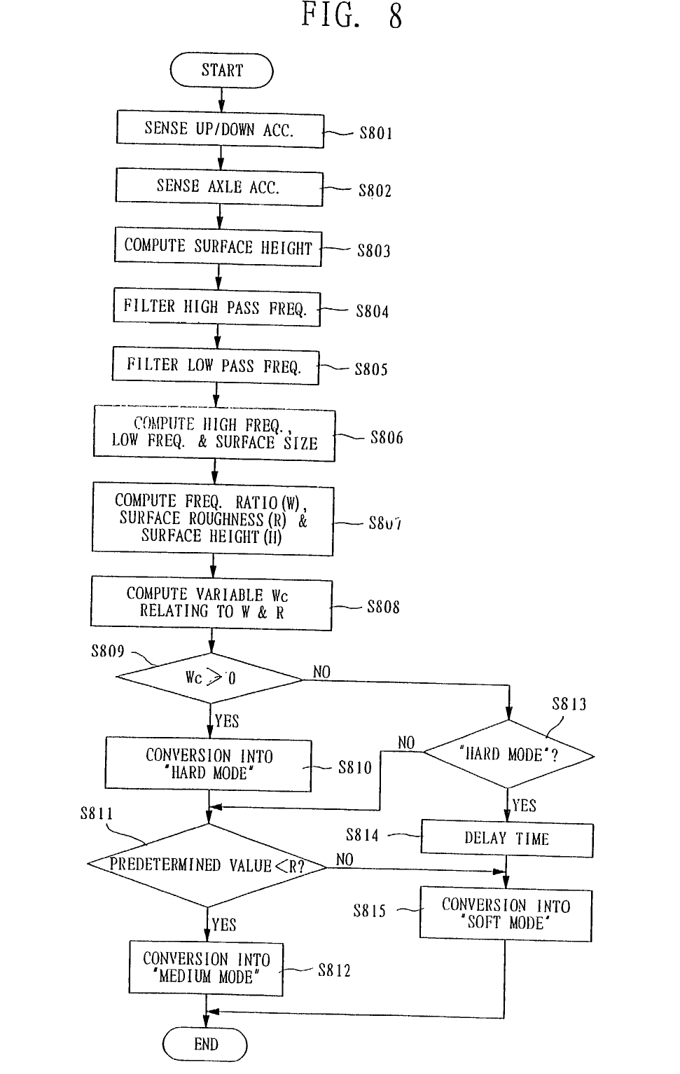

Now, the operations of the adaptive electronic suspension 1o system according to the preferred embodiments of the present invention will be described in more detail with reference to FIG. 3 to FIG. 8.

### Embodiment 1

The electronic controller 10 senses a vehicle speed according to a detecting signal output from the vehicle speed sensor 1 (S301), and senses a steering angle according to a detecting signal output from the steering angle sensor 2 (S302).

An odd number variable S is obtained by computing following formula 1 from the vehicle speed from the vehicle sensor 1 and the steering angle from the steering angle sensor 2 (S303).

S=coefficient×sensor absolute value+coefficient×amount of sensor acceleration change×speed. (Formula 1)

The electronic controller 10 determines whether the odd number variable S is smaller than a predetermined value Crl, that is, a reference value for determining on/off of roll control (S304).

As a result, if the odd number variable S is larger than the predetermined value Crl, the electronic controller 10 drives the front and rear actuators 7, 8 which are mounted on an upper part of the damper to change a passage by rotation of a control rod, thereby converting a damping force of a wheel damper into “hard mode” (S305). On the other hand, the electronic controller 10 converts the damping force of the wheel damper into “soft mode” after a predetermined time delay (S307) when the odd number variable S is smaller than the predetermined value Crl in “hard mode”, wherein if the damping mode of the wheel damper is not in “hard mode”, the electronic controller 10 finishes all functions (S308)

### Embodiment 2

The electronic controller 10 senses a vehicle speed according to a detecting signal output from the vehicle speed sensor 1 (S401), and senses an opening amount of the throttle valve which is mounted on the intake manifold by a detecting signal which is output from the throttle position sensor (S402).

That is, the electronic controller 10 differentiates the opening amount of the throttle valve from a position value which is detected by the TPS 3 (S403). After that, the electronic controller 10 computes a squirt variable Q from a position value of the throttle valve which is sensed by the TPS 3 and a vehicle speed by formula 2 (S404).

Q=coefficient×sensor differentiated amount×W (Formula 2)

Then, the electronic controller 10 determines whether the squirt variable Q is smaller than the predetermined value Crl (S405) If the squirt variable Q is larger than the predetermined value Crl, the electronic controller 10 drives the front and rear wheel actuators 7, 8 to change the passage by the rotation of the control rod so that a damping force of a wheel damper is converted into “medium mode” (S406). On the other hand, the damping force of the wheel damper is converted into “soft mode” (S408) if the squirt variable Q is smaller than the predetermined value and the damping mode of the wheel damper is in “medium mode” (S407).

### Embodiment 3

The electronic controller 10 senses a vehicle speed by a detecting signal which is output from the vehicle speed sensor 1 (S501) and an up/down acceleration value G according to an output detecting signal from the up/down acceleration sensor 2 (S502), and reads a value of control map (S503).

The electronic controller 10 determines whether a vehicle speed of the vehicle speed sensor 1 is smaller than or equal to a reference vehicle speed V1 in the range of 100 km/h˜130 km/h (S504). As a result, the electronic controller 10 determines whether an absolute value of the up/down acceleration value G is larger than or equal to a predetermined value g1 (S505), when the vehicle speed is smaller than or equal to the reference value V1.

The electronic controller 10 converts a damping force of a wheel damper into “hard mode” when the absolute value of the up/down acceleration value G is larger than or equal to the predetermined value g1 (S506˜S508).

That is, the electronic controller 10 converts a damping force of front wheels into “hard mode” when the absolute value of the up/down acceleration value G is larger than or equal to the predetermined value g1 (S506), and converts the damping force of rear wheels into “hard mode” (S508) after a predetermined time delay (S507).

On the other hand, the electronic controller 10 determines whether the damping force of the wheel damper is in “hard mode” (S509) when the absolute value of the up/down acceleration G is larger than the predetermined value g. If the damping force of the wheel damper is determined to be in “hard mode”, the electronic controller 10 converts the damping force of the wheel damper from “hard mode” into “medium mode” (S511) after a predetermined time delay (S510), and further converts it from “medium mode” into “soft mode” in sequence (S512).

The electronic controller 10 compares the vehicle speed of the vehicle speed sensor 1 with a reference vehicle speed V3 in the range of 150 km/h˜180 km/h (S513), when the vehicle speed is determined to be larger than the reference vehicle speed V1 in the step S504. As a result, if the vehicle speed is larger than or equal to the reference value V3, the electronic controller 10 determines whether the absolute value of the up/down acceleration value G is larger than or equal to the predetermined value g (S514).

When the absolute value of the up/down acceleration value G is determined to be larger than the predetermined value g, the electronic controller 10 converts the damping force of the front wheels into “hard mode” (S506) and, after a predetermined time delay (S507), converts the damping force of the rear wheels into “hard mode” (S508). On the other hand, when the absolute value of the up/down acceleration value G is determined to be smaller than or equal to the predetermined value g, the electronic controller 10 determines whether the damping force of the wheel dampers are in “hard mode” (S509) and, after a predetermined time delay (S510), converts the damping force of the wheel dampers via “medium mode” (S511) to “soft mode” (S512) in sequence.

Further, if the vehicle speed is smaller than or equal to the reference vehicle speed V3 as a result of comparison of the vehicle speed with the reference vehicle speed V3 (S513), the electronic controller 10 determines whether the absolute value of the up/down acceleration value G is larger than or equal to a predetermined value g2 (S515).

If the absolute value of the up/down acceleration value G is larger than or equal to the predetermined value g2, the electronic controller 10 converts the damping force of the front wheels into “hard mode” (S506) and, after a predetermined time delay (S507), converts the damping force of the rear wheels into “hard mode” (S508) On the other end, when the absolute value of the up/down acceleration value G is determined to be smaller than the predetermined value g2, the electronic controller 10 determines whether the damping force of the wheel dampers is in “hard mode” (S509). If the damping force of the wheel dampers is determined to be in “hard mode”, the electronic controller 10 converts the damping force of the wheel dampers via “medium mode” (S511) to “soft mode” (S512) in sequence, after the predetermined time delay (S510).

### Embodiment 4

First of all, the electronic controller 10 checks an operation state of the brake switch 5, which is to be turned on/off according to the operation of the brake (S610). On the other hand, the electronic controller 10 senses a vehicle speed by a detecting signal output from the vehicle speed sensor 1 (S602), thereby the electronic controller 10 computes a damping speed dV from the vehicle speed (S603).

The electronic controller 10 compares a predetermined damping speed dV1 with the damping speed dV (S604). If the damping speed dV is larger than the predetermined damping speed dV1, the damping speed dV is compared with another predetermined damping speed dV2 (S605)

As a result, if the damping speed dV is smaller than the predetermined damping speed dV2, the electronic controller 10 turns on the emergency warning light 9 to be blinking (S606) and converts the damping force of a wheel damper into “hard mode” (S607). On the other hand, if the damping speed dV is not smaller than the predetermined damping speed dV2, the electronic controller 10 directly converts the damping force of the wheel damper into “hard mode” (S607) without turning on the emergency warning light 9.

Further, if the damping speed dV is not larger than the predetermined damping speed dV1 in step S604, it is determined whether the damping force mode of the wheel damper is in “hard mode”. If the damping force mode of the wheel damper is not in “hard mode”, the operation is finished without conversion of damping force mode. On the other hand, if the damping force mode of the wheel damper is in “hard mode”, the electronic controller 10 converts the damping force of the wheel damper into “soft mode” (S613) after a predetermined time delay (S612).

If it is determined that the brake switch 5 is turned off, indicative of non-operation of the brake (S601), the electronic controller 10 checks whether the emergency warning light 9 is flicking, that is, the emergency warning light 9 is turned on (S608).

If the warning light 9 is determined to be turned on, the electronic controller 10 turns off the warning light 9 after a predetermined time delay (S609), and checks whether the damping mode of the wheel damper is in “hard mode” (S611). If the damping mode of the wheel damper is not in “hard mode”, the operation is finished without conversion of damping force mode. On the other hand, if the damping force mode of the wheel damper is in “hard mode”, and the electronic controller 10 converts the damping force of the wheel damper into “soft mode” (S613) after a predetermined time delay (S612). Of course, if the warning light 9 is maintained being turned off, the electronic controller 10 controls to perform above steps S611˜S613.

### Embodiment 5

First of all, the electronic controller 10 senses a vehicle speed by a detecting signal which is output from the vehicle speed sensor 1 (S701), and checks whether the vehicle speed is smaller than 5 km/h (S702). As a result, if the vehicle speed is smaller, the electronic controller 10 controls to convert a damping force of a wheel damper into “hard mode” (S703), while if the vehicle speed is not smaller, the electronic controller 10 checks whether the vehicle speed is larger than a predetermined vehicle speed V3 (S704).

The electronic controller 10 checks the damping force mode of the wheel damper, if the vehicle speed is determined not to be larger than the predetermined vehicle speed V3 (S710). In case of “medium mode”, the damping force of the wheel damper is converted into “soft mode” (S712) only when the vehicle speed is smaller than the predetermined vehicle speed V3 which is deducted by 10 km/h (S711).

On the other hand, if the vehicle speed is determined to be larger than the predetermined vehicle speed V3, the electronic controller 10 compares the vehicle speed with a predetermined vehicle speed V4 (S705), to convert the damping force of the wheel damper into “hard mode” if the vehicle speed is larger than the predetermined vehicle speed V4 (S706). If the vehicle speed is determined not to be larger than the predetermined vehicle speed V4, the damping force mode of the wheel damper is checked (S707), so that the damping force of the wheel damper is converted into “medium mode” (S709) only when the vehicle is smaller than the predetermined vehicle speed V4 which is deducted by 10 km/h (S708) On the other hand, if the damping force of the wheel damper is not in “hard mode”, it is directly converted into “medium mode” (S709).

### Embodiment 6

First of all, the electronic controller 10 senses an up/down acceleration value and an axle acceleration value respectively from the up/down acceleration sensor 4 and the axle acceleration sensor 6 (S801, S802). The electronic controller 10 computes a surface height from the up/down acceleration value and the axle acceleration value (S803) and filters obtained values by a high pass filter and a low pass filter, respectively (S804, S805).

After processing the up/down acceleration value and the axle acceleration, the electronic controller 10 obtains average data values of the up/down acceleration value, the axle acceleration value and the surface size, that is, average values of high frequency, low frequency and surface size (S806).

The electronic controller 10 computes a frequency ratio W, a surface roughness R, and a surface height H from the average values of the high frequency, the low frequency and the surface size (S807). After that, the electronic controller 10 obtains a variable Wc in relation to the frequency ratio W and the surface roughness R (S808)

The electronic controller 10 compares the variable Wc with “0” (S809), to convert a damping force of a wheel damper into “hard mode” when the variable Wc is larger than “0” (S810). After the conversion into “hard mode”, the electronic controller 10 compares the surface roughness R with a predetermined value (S811). If the surface roughness R is larger than the predetermined value, the electronic controller 10 converts the damping force of the wheel damper into “medium mode” (S812), while if the surface roughness R is not larger than the predetermined value, the electronic controller 10 converts the damping force of the wheel damper into “soft mode” (S515).

Further, if the surface roughness R is not larger than the predetermined value, the electronic controller 10 checks whether the damping force of the wheel damper is in “hard mode”, so as to convert the damping force of the wheel damper into “soft mode” in case of “hard mode” after a predetermined time delay (S814) On the other hand, in case of any other mode than “hard mode”, the electronic controller 10 checks again whether the surface roughness R is larger than the predetermined value (S811) If the surface roughness R is larger than the predetermined value, the electronic controller 10 converts the damping force of the wheel damper into “medium mode” (SB12), or into “soft mode” if the surface roughness R is not larger than the predetermined value (S815).

### Effect of the Invention

As described hereinabove, according to the present invention, since it is easy to manufacture the shaft and the rotor, it becomes possible to improve the driving performance and steering stability by controlling the damping force of the variable damper considering vehicle speed, steering angle, opening amount of throttle valve, up/down acceleration, brake operation, axle acceleration etc.

Although the preferred embodiments of the present invention have been disclosed for illustrative purposes, those skilled in the art will appreciate that various modifications, additions and substitutions are possible, without departing from the scope and spirit of the invention as described in the accompanying claims.

What is claimed is

1. A control method for an adaptive electronic suspension system, comprising the steps of:
sensing a vehicle speed by a detecting signal which is output from a vehicle speed sensor;
sensing a steering angle by a detecting signal which is output from a steering angle sensor;
computing an odd number variable from the vehicle speed and the steering angle;
determining the odd number variable is smaller than a predetermined value; and
converting a damping force of a wheel damper into “hard mode” when the odd number variable is larger, and converting the damping force of the wheel damper into “soft mode” after a time delay when the odd number variable is smaller and a damping force of a wheel damper is in “hard mode”.

2. A control method for an adaptive electronic suspension system, comprising the steps of:
sensing a vehicle speed by a detecting signal which is output from a vehicle speed sensor;
sensing an opening amount of a throttle valve mounted on an intake manifold by a detecting signal which is output from a throttle position sensor;
differentiating the opening amount of the throttle valve from the throttle position sensor;
computing a squirt variable (Q) from the opening amount of the throttle valve from the throttle position sensor;
determining as to whether the squirt variable (Q) is smaller than a predetermined value (Crl); and
converting a damping force of a wheel damper into “medium mode” when the squirt variable (Q) is larger than the predetermined value (Crl), while converting the damping force of the wheel damper into “soft mode” when the squirt variable (Q) is smaller than the predetermined value and the damping mode of the wheel damper is recognized to be “medium mode”

3. A control method for an adaptive electronic suspension system, comprising the steps of:
sensing a vehicle speed by a detecting signal which is output from a vehicle speed sensor;
sensing an up/down acceleration value (G) according to a detecting signal output from an up/down acceleration sensor;
reading a value of control map;
determining as to whether the vehicle speed of the vehicle speed sensor is smaller than or equal to a reference vehicle speed (V1);
determining as to whether an absolute value of the up/down acceleration value G is larger than or equal to a predetermined value (g1), when the vehicle speed is smaller than or equal to the reference value (V1);
converting a damping force of a wheel damper into “hard mode” when the absolute value of the up/down acceleration value G is larger than or equal to the predetermined value (g1);
converting the damping force of the wheel damper from “hard mode” into “soft mode” in sequence, when the absolute value of the up/down acceleration value (G) is smaller than the predetermined value (g1), or when the vehicle speed is smaller than the absolute value of the up/down acceleration value (G) and predetermined values (g, g2) according to sizes of the vehicle speed and the reference vehicle speed value (V3) if the vehicle speed is smaller than the reference vehicle speed (V1); and
converting the damping force of the wheel damper into “hard mode” when the absolute value of the up/down acceleration speed value (G) is larger than or equal to the predetermined values (g, g2), after comparing the absolute value of the up/down acceleration speed value (G) with the predetermined values (g, g2) according to the sizes of the vehicle speed and the reference vehicle speed value (V3) if the vehicle speed is smaller than the reference vehicle speed (V1).

4. A control method for an adaptive electronic suspension system as claimed in claim 3, wherein when the absolute value of the up/down acceleration value (G) is larger than or equal to the predetermined value (g1), damping force of front wheels is converted into “hard mode” and, after a predetermined time delay, damping force of rear wheels is converted into “hard mode”.

5. A control method for an adaptive electronic suspension system as claimed in claim 3, wherein the damping force of the wheel damper is converted sequentially from “hard mode” into “soft mode” in such a manner that it is determined whether the damping force of the wheel damper is “hard mode” and the predetermined time is delayed if “hard mode”, so that the damping force of the wheel damper is converted from “hard mode” into “soft mode” via “medium mode” in sequence, while it is converted directly into “soft mode” if it is not determined that the damping force of the wheel damper is in “hard mode”.

6. A control method for an adaptive electronic suspension system as claimed in claim 3, wherein when the vehicle speed is larger than the reference vehicle speed (V1), the vehicle speed is compared with the reference vehicle speed (V3) so that the damping force of the wheel damper is converted according to the size of the absolute value of the up/down acceleration vehicle speed (G) and the predetermined value (g) when the vehicle speed is larger than the reference vehicle speed (V3), while the damping force of the wheel damper is converted according to the size of the absolute value of the up/down acceleration vehicle speed (G) and the predetermined value (g2) when the vehicle speed is smaller than or equal to the reference vehicle speed (V3).

7. A control method for an adaptive electronic suspension system comprising the steps of:
determining operation state of a brake switch;
computing a damping force (dV) by reading vehicle speed;
comparing the damping speed (dV) with a predetermined damping speed (dV1);
converting a damping force of a wheel damper into “soft mode”, after a predetermined time delay, when the damping speed (dV) is smaller than the predetermined damping speed (dV1) or it is “hard mode” and the brake is not in operation; and
converting the damping force of the wheel damper into “hard mode” when the damping speed (dV) is larger than the predetermined damping speed (dV1) but smaller than a predetermined damping speed (dV2), and converting the damping force of the wheel damper into “hard mode” during an emergency warning light is blinking when the damping speed (dV) is larger than the random damping speed (dV2).

8. A control method for an adaptive electronic suspension system as claimed in claim 7, wherein in case of non-operation of the brake, the conversion of the damping force of the wheel damper is performed as the emergency warning light operates and, in case of operation of the brake, the conversion of the damping force of the wheel damper is performed after the emergency warning light is turned off.

9. A control method for an adaptive electronic suspension system comprising the steps of:
sensing a vehicle speed by a detecting signal which is output from a vehicle speed sensor;
determining as to whether the vehicle speed is smaller than 5 km/h, to convert a damping force of a wheel damper into “hard mode” if smaller, and determining as to whether the vehicle speed is larger than a predetermined vehicle speed (V3) if not smaller;
converting the damping force of the wheel damper in response to change of vehicle speed if the vehicle speed is determined not to be larger than the predetermined vehicle speed (V3); and
comparing the vehicle speed with a predetermined vehicle speed (V4) if the vehicle speed is determined to be larger than the predetermined vehicle speed (V3), to convert the damping force of the wheel damper.

10. A control method for an adaptive electronic suspension system as claimed in claim 9, wherein if the vehicle speed is not larger than the predetermined vehicle speed (V3), the damping force of the wheel damper is checked, so as to convert the damping force of the wheel damper into “soft mode” only when the vehicle speed is smaller than the predetermined vehicle speed (V3) which is deducted by 10 km/h in “medium mode”, and to convert the damping force of the wheel damper into “soft mode” directly in any other mode than “medium mode”.

11. A control method for an adaptive electronic suspension system as claimed in claim 9, wherein if the vehicle speed is larger than the predetermined vehicle speed (V3), the damping force of the wheel damper is converted in response to change of the vehicle speed when the vehicle speed is not larger, and to convert the damping force of the wheel damper is converted into “hard mode” when the vehicle speed is larger.

12. A control method for an adaptive electronic suspension system as claimed in claim 9, wherein if the vehicle speed is not larger than the predetermined vehicle speed (V4), the damping force of the wheel damper is checked so as to convert the damping force of the wheel damper into “medium mode” only when the vehicle speed is smaller than the predetermined vehicle speed (V4) which is deducted by 10 km/h in “hard mode”, and to convert the damping force of the wheel damper into “medium mode” directly in any other mode than “hard mode”.

13. A control method for an adaptive electronic suspension system comprising the steps of:
obtaining a frequency ratio (W), a surface roughness (R), and a surface height (H) by processing an up/down acceleration value and an axle acceleration value;
obtaining a variable Wc in relation to the frequency ratio (W) and the surface roughness (R);
comparing the variable (Wc) with “0”, to convert a damping force of a wheel damper into “hard mode” when the variable (Wc) is larger than “0”, and to convert the damping force of the wheel damper according to the surface roughness (R); and
checking the damping force of the wheel damper when the variable Wc is not larger than “0”, to convert the damping force of the wheel damper into “soft mode” in case of “hard mode”, and to convert the damping force of the wheel damper into “medium mode” or “soft mode” according to the surface roughness R in case of any other mode than “hard mode”.

14. A control method for an adaptive electronic suspension system as claimed in claim 13, wherein after converting the wheel damper into “hard mode”, the damping force of the wheel damper is converted into “medium mode” if the surface roughness (R) is smaller than a predetermined value and the damping force of the wheel damper is converted into “hard mode” if the surface roughness (R) is not smaller than the predetermined value.

15. A controller for an adaptive electronic suspension system comprising:
a vehicle speed sensor for detecting a vehicle speed;
a steering angle sensor for detecting a steering angle;
a throttle position sensor for detecting an opening amount of a throttle valve which is mounted on an intake manifold;
an up/down acceleration sensor for detecting an acceleration in the up and down directions of a vehicle;
a brake switch for detecting whether a brake in operation or not;
an axle acceleration sensor for detecting an acceleration in the direction of axle of the vehicle; and
an electronic controller for controlling damping forces of dampers of four wheels into “hard mode”, “medium mode” and “soft mode” in such a manner that a driving state of the vehicle is determined according to detecting signals output from the vehicle sensor, the steering angle sensor, the throttle position sensor, the up/down acceleration sensor, the axle acceleration sensor and the brake switch, and front actuators and rear actuators which are mounted on upper parts of the wheel dampers are driven to change passages by rotation of control rods.
